(19) United States
(12) Patent Application Publication
(10) Pub. No.: US 2017/0161117 A1
(43) Pub. Date: Jun. 8, 2017

(54) APPARATUS AND METHOD TO DETERMINE A SERVICE TO BE SCALED OUT BASED ON A PREDICTED VIRTUAL-MACHINE LOAD AND SERVICE IMPORTANCE

(71) Applicant: FUJITSU LIMITED, Kawasaki-shi (JP)

(72) Inventor: Junichi Fukuda, Kawasaki (JP)

(73) Assignee: FUJITSU LIMITED, Kawasaki-shi (JP)

(21) Appl. No.: 15/358,500

(22) Filed: Nov. 22, 2016

(30) Foreign Application Priority Data
Dec. 7, 2015 (JP) 2015-238358

(51) Int. Cl. G06F 9/50; G06F 9/455

(52) U.S. Cl. CPC G06F 9/5077; G06F 9/45533

(57) ABSTRACT

An apparatus detects, from plural virtual-machines that provide services, first and second virtual-machines that provide first and second services, respectively, and that each have a load exceeding a threshold value. The apparatus determines a first priority with which a first extension virtual-machine is to be added for the first service, based on a predicted load-value of the first virtual-machine after a lapse of a specific time-period, and a degree of importance of the first service, and determines a second priority with which a second extension virtual-machine is to be added for the second service, based on a predicted load-value of the second virtual-machine after a lapse of a specific time-period, and a degree of importance of the second service. The apparatus determines, as a preferential extension virtual-machine to be added with a higher priority, a virtual-machine that provides a service having higher one of the first and second priorities.

### CROSS-REFERENCE TO RELATED APPLICATION

This application is based upon and claims the benefit of priority of the prior Japanese Patent Application No. 2015-238358, filed on Dec. 7, 2015, the entire contents of which are incorporated herein by reference.

### FIELD

The embodiments discussed herein are related to apparatus and method to determine a service to be scaled out based on a predicted virtual-machine load and service importance.

### BACKGROUND

Virtual machines that are allocated a resource of an information processing apparatus provide users with a variety of services. The services provided by the virtual machine may include a voice service, and a mail service, for example. The virtual machine that provides such services may be overloaded as requests for the services increase. In such a case, a virtual machine is newly added, and the load may be distributed by increasing the number of virtual machines. Increasing the number of virtual machines is referred to as “scale-out”.

A technique for transferring a virtual machine has been disclosed as virtual machine technique. In this technique, a virtual machine management apparatus determines whether to transfer a target virtual machine, depending on load information of a source server and a destination server. A technique related to a method of determining a transfer destination of a virtual machine has been disclosed. In this technique, a control apparatus determines a physical server to which a virtual machine is to be transferred, depending on load information of each virtual machine, the priority order of physical servers, and constraint condition information of the physical servers.

Reference is made to Japanese Laid-open Patent Publication No. 2011-108014 and Japanese Laid-open Patent Publication No. 2011-13822 for further information.

### SUMMARY

According to an aspect of the invention, an apparatus detects a first virtual machine that provides a first service and a second virtual machine that provides a second service, each having a load that has exceeded a threshold value, from a plurality of virtual machines that provide services. The apparatus determines a first priority with which a first extension virtual machine is to be added for the first service, in accordance with a first predictive load value that is a predicted value of a first load of the first virtual machine after a lapse of a specific period of time, and a degree of importance of the first service, and determines a second priority with which a second extension virtual machine is to be added for the second service, in accordance with a second predictive load value that is a predicted value of a second load of the second virtual machine after a lapse of a specific period of time, and a degree of importance of the second service. The apparatus determines, as a preferential extension virtual machine that is to be added with a higher priority, a virtual machine that provides a service having higher one of the first and second priorities.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a virtual machine extension system, according to an embodiment;

FIG. 2 is a diagram illustrating an example of a virtual machine extension system, according to an embodiment;

FIG. 3 is a diagram illustrating an example of a virtual machine that operates on a virtual machine extension system, according to an embodiment;

FIG. 4 is a diagram illustrating an example of a hardware configuration of a management server, according to an embodiment;

FIG. 5 is a diagram illustrating an example of a state transition chart of services, according to an embodiment;

FIG. 6 is a diagram illustrating an example of functions of a management server, according to an embodiment;

FIG. 7 is a diagram illustrating an example of a correspondence relationship between an excess traffic ratio and a degree of importance, according to an embodiment;

FIG. 8 is a diagram illustrating an example of an overall resource management table, according to an embodiment;

FIG. 9 is a diagram illustrating an example of a state management table, according to an embodiment;

FIG. 10 is a diagram illustrating an example of a usage resource table, according to an embodiment;

FIG. 11 is a diagram illustrating an example of a log table, according to an embodiment;

FIG. 12 is a diagram illustrating an example of a reservation resource table, according to an embodiment;

FIG. 13 is a diagram illustrating an example of a setting file, according to an embodiment;

FIG. 14 is a diagram illustrating an example of an operational flowchart for a process of state transition, according to an embodiment;

FIG. 15 is a diagram illustrating an example of an amount of reservation resource, according to an embodiment;

FIG. 16 is a diagram illustrating an example of an operational flowchart for a process of state transition, according to an embodiment;

FIG. 17 is a diagram illustrating an example of an operational flowchart for a process of state transition, according to an embodiment;

FIG. 18 is a diagram illustrating an example of an operational flowchart for a process performed when a predictive traffic amount becomes less than a threshold value, according to an embodiment;

FIG. 19 is a diagram illustrating an example of an operational flowchart for a process performed when a reservation resource amount is allocatable with a virtual machine (VM) startup not on standby, according to an embodiment;

FIG. 20 is a diagram illustrating an example of an operational flowchart for a process of state transition, according to an embodiment;

FIG. 21 is a diagram illustrating an example of an operational flowchart for a process of state transition, according to an embodiment;

FIG. 22 is a diagram illustrating an example of a scale-out operation, according to an embodiment;

FIG. 23 is a diagram illustrating an example of a scale-out operation, according to an embodiment;

FIG. 24 is a diagram illustrating an example of a scale-out operation, according to an embodiment;

FIG. 25 is a diagram illustrating an example of a scale-out operation, according to an embodiment;

FIG. 26 is a diagram illustrating an example of a scale-out operation, according to an embodiment;

FIG. 27 is a diagram illustrating an example of a scale-out operation, according to an embodiment;

FIG. 28 is a diagram illustrating an example of a scale-out operation, according to an embodiment;

FIG. 29 is a diagram illustrating an example of a scale-out operation, according to an embodiment;

FIG. 30 is a diagram illustrating an example of a scale-out operation, according to an embodiment;

FIG. 31 is a diagram illustrating an example of a scale-out operation, according to an embodiment;

FIG. 32 is a diagram illustrating an example of a scale-out operation, according to an embodiment; and

FIG. 33 is a diagram illustrating an example of a scale-out operation, according to an embodiment.

### DESCRIPTION OF EMBODIMENTS

It takes time to construct and start up a virtual machine that provides a specific service. While a virtual machine to be newly added is under construction, another virtual machine configured to provide a service higher in importance than the service provided by the first virtual machine may be overloaded. In this case, sufficient resources may not be available to construct the new virtual machine. When available resources are not sufficient, it is contemplated that the construction of the virtual machine, which is under construction, is suspended, and the resource is released and allocated to a virtual machine that provides a service of higher importance.

However, even if the load of a virtual machine providing a service having a high degree of importance becomes too large, the urgency of the scale-out of the service is not necessarily highest at that moment. For example, when an increase in the load of the service having a high degree of importance is temporary, another service having an increased load has more urgent scale-out. In such a case, when the virtual machine providing the service of the high degree of importance is scaled out with a higher priority, it may be difficult to scale out the virtual machine providing the more urgent service because of insufficient resources. In this way, the loads of the virtual machines providing services are varying continuously. Merely scaling out a service having a high degree of importance with a higher priority may be inappropriate in terms of operational efficiency of the entire system.

It is preferable to appropriately determine a service that is to be provided by adding a virtual machine.

Embodiments of the disclosure are described below with reference to the drawings.

### First Embodiment

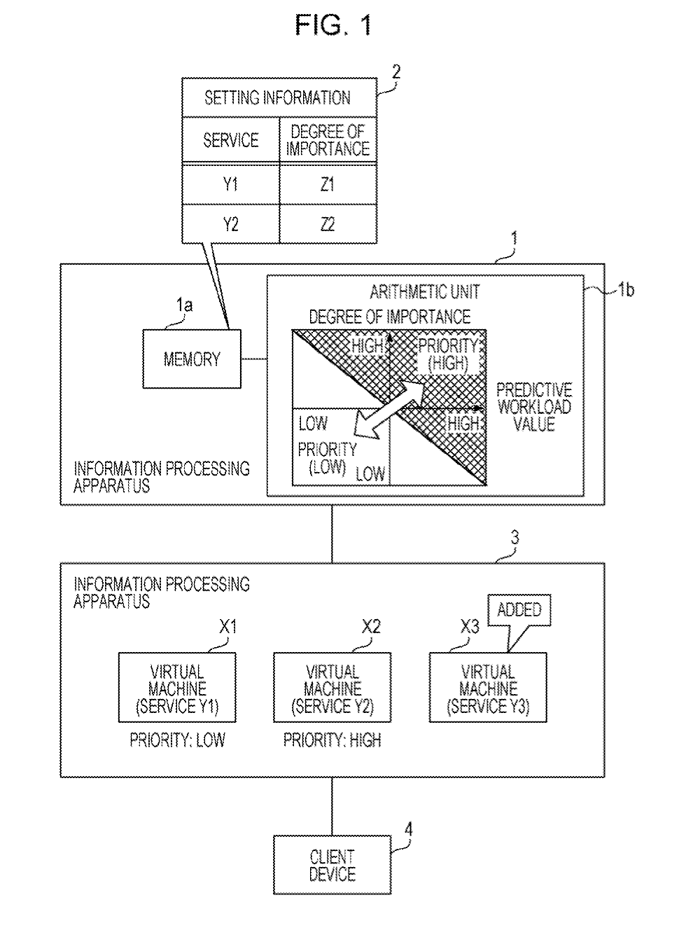

FIG. 1 illustrates a virtual machine extension system of a first embodiment. The virtual machine extension system includes an information processing apparatus 1 and an information processing apparatus 3. The information processing apparatus 1 is coupled to the information processing apparatus 3 via a network.

The information processing apparatus 3 operates multiple virtual machines. For example, the information processing apparatus 3 operates a virtual machine X1 and a virtual machine X2. The virtual machines X1 and X2 operate when a hypervisor in the information processing apparatus 3 allocates resources of the information processing apparatus 3 to the virtual machines X1 and X2. The information processing apparatus 3 is coupled to a client device 4 via a network. The client device 4 is a device used by a user. The client device 4 receives services provided by the virtual machines X1 and X2 operated by the information processing apparatus 3.

The information processing apparatus 1 includes a memory 1a and an arithmetic unit 1b. The memory 1a may be a volatile memory device, such as a random-access memory (RAM), or a non-volatile memory device, such as a hard disk drive (HDD) or a flash memory. The arithmetic unit 1b is a processor, for example. The processor may include a central processing unit (CPU), a digital signal processor (DSP), an application specific integrated circuit (ASIC), or a field programmable gate array (FPGA). Alternatively, the arithmetic unit 1b may be a multi-processor.

The memory 1a stores setting information 2 that indicates a correspondence relationship between services provided by multiple virtual machines operated by the information processing apparatus 3 and degrees of importance of the services. For example, the setting information 2 indicates that a service Y1 provided by the virtual machine X1 has a degree of importance Z1. The setting information 2 indicates that a service Y2 provided by the virtual machine X2 has a degree of importance Z2. The memory 1a stores information indicating that the virtual machine X1 provides the service Y1 and the virtual machine X2 provides the service Y2.

The arithmetic unit 1b monitors the loads of the multiple virtual machines operated by the information processing apparatus 3. For example, as requests from the client device 4 to the virtual machines X1 and X2 increase, the arithmetic unit 1b detects an increase in the loads of the virtual machines X1 and X2. The arithmetic unit 1b determines whether each of the loads of the virtual machines X1 and X2 exceeds a threshold value.

When there is a virtual machine whose load has exceeded the threshold value, the arithmetic unit 1b determines the priority of virtual machine extension for a service, based on a predictive load value that indicates a predicted value, at a time specific time period later, of a load of the virtual machine whose load has exceeded the threshold value, and the degree of importance of the service provided by each virtual machine.

When the load of the virtual machine X1 has exceeded the threshold value, the arithmetic unit 1b determines the priority of virtual machine extension for the service Y1, based on the predictive load value of the virtual machine X1 and the degree of importance Z1 of the service Y1 provided by the virtual machine X1. When the load of the virtual machine X2 has exceeded the threshold value, the arithmetic unit 1b determines the priority of virtual machine extension for the service Y2, based on the predictive load value of the virtual machine X2 and the degree of importance Z2 of the service Y2 provided by the virtual machine X2.

The predictive load value is calculated in accordance with a predicted value that is expected to increase from a current time point until the completion of the construction of a virtual machine. The higher the degree of importance of a service is, the higher the value of the priority of the service becomes, and also, the higher the predictive load value of the virtual machine providing the service is, the higher the value of the priority of the service becomes.

The arithmetic unit 1b determines that the virtual machine providing a service with a higher priority is constructed with a higher priority. For example, when the service Y2 is higher in priority than the service Y1, the arithmetic unit 1b determines that a virtual machine X3 providing the service Y2 is constructed with a higher priority. The arithmetic unit 1b then instructs the information processing apparatus 3 to construct the virtual machine X3 that provides the service Y2.

In accordance with the first embodiment, the priority is calculated in view of the degree of importance and urgency of the service. Based on the priority, the service that desires the addition of a virtual machine is appropriately determined.

Since a future load on a virtual machine is predicted from a predictive load value, the urgency of the virtual machine as a scale-out target is determined. The priority is thus calculated, based on the predictive load value and the degree of importance. In this way, the priority is determined from the degree of importance and urgency of the service. When there are multiple services that desire the addition of a virtual machine, the service that desires the addition of the virtual machine is determined in accordance with the priority. In other words, in view of the degree of importance and urgency of the service, the service that desires the addition of the virtual machine is determined.

A service as a scale-out target is determined in view of the urgency of the service in addition to the degree of importance of the service. For example, when a virtual machine providing a service of a high degree of importance is overloaded, but the urgency thereof is low, another service having a higher degree of scale-out urgency may be scaled out with a higher priority. In this way, the resources of the system are generally effectively used, and service quality is improved.

Upon detecting the load of a virtual machine having exceeded a threshold value, the arithmetic unit 1b may start an extension operation of another virtual machine that provides the same service as that of the virtual machine. More specifically, the arithmetic unit 1b transmits image data of the virtual machine to the information processing apparatus 3 while instructing the information processing apparatus 3 to start up the virtual machine based on the image data. The arithmetic unit 1b may repeat the calculation of the priority of each service during a time period remaining until the virtual machine providing the service is start up, while performing a construction operation of the virtual machine. In a case where the priority is repeatedly calculated, the arithmetic unit 1b performs a determination operation to determine a virtual machine to be constructed with a higher priority each time the priority of the service is calculated, and updates determination results of the virtual machine that is constructed with a higher priority. In this way, the arithmetic unit 1b appropriately determines a service of a virtual machine as an extension target in accordance with the predictive load value that dynamically changes.

When the load of the virtual machine exceeds the threshold value, the extension operation of another virtual machine providing the same service may start. In such a case, the startup of a virtual machine providing a service having a lower priority may be completed prior to the startup of a virtual machine providing a service having a higher priority. In the case, the arithmetic unit 1b releases the resource by saving the state of the virtual machine providing the service having the lower priority to a storage device. The operation to save the state of the virtual machine to the storage device is referred to as, for example, a hibernation operation. More specifically, the arithmetic unit 1b instructs the information processing apparatus 3 to perform the hibernation operation to the virtual machine providing the service having the lower priority.

By causing the virtual machine providing the service having the lower priority to release the resource, the resource that is to be allocated to the virtual machine providing the service having the higher priority is more easily obtained. The arithmetic unit 1b allocates the resource to a virtual machine providing the service having the higher priority and instructs the information processing apparatus 3 to start up the virtual machine.

This allows the virtual machine providing the service having the higher priority to be started up without delay even when the startup of the virtual machine providing the service having the lower priority is completed earlier. Further, the state of the virtual machine providing the service having the lower priority is saved on the storage device. For this reason, when there still remains an available resource that may be allocated to the virtual machine providing the service having the lower priority, subsequent to the startup of the virtual machine providing the service having the higher priority, the virtual machine providing the service having the lower priority may be quickly started up.

Since the extension operation of the virtual machine takes time, the predictive load value as a calculation result may be less than the threshold value. In such a case, the arithmetic unit 1b suspends the construction operation of the virtual machine. In this way, needless construction of virtual machines is avoided.

### Second Embodiment

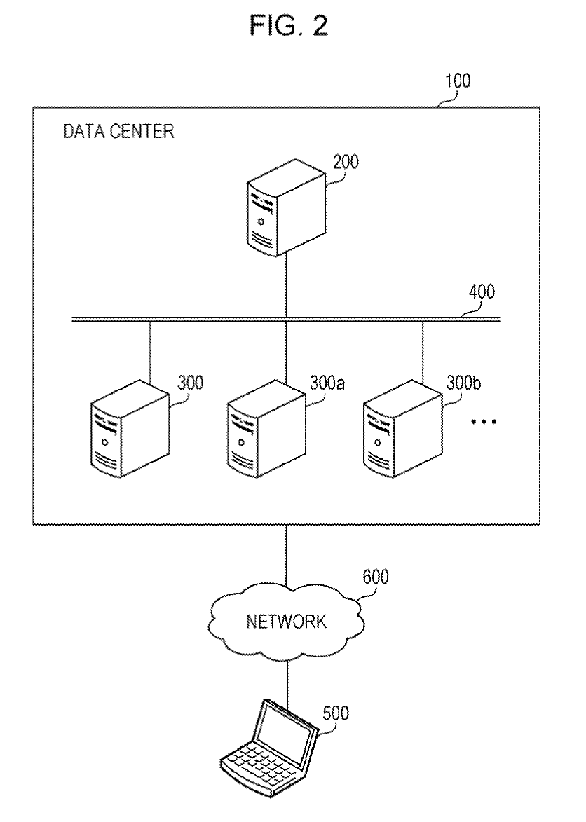

FIG. 2 illustrates a virtual machine extension system of a second embodiment. The virtual machine extension system of the second embodiment is constructed in a data center 100. The data center 100 includes a management server 200, and business servers 300, 300a, 300b, . . . . The management server 200, and the business servers 300, 300a, 300b, . . . are coupled to each other via a network 400. The network 400 is a local-area network (LAN). The data center 100 and a client device 500 are coupled to each other via a network 600. For example, the network 600 may be a wide-area network (WAN) or the Internet. The client device 500 may access the management server 200, and the business servers 300, 300a, 300b, . . . via the network 600.

The management server 200, and the business servers 300, 300a, 300b, . . . are server computers. The management server 200 may scale out virtual machines (VMs) operating in the business servers 300, 300a, 300b, . . . .

The client device 500 is a client computer to be used by a user. FIG. 2 illustrates only one client device 500, but multiple client devices may be used. The client device 500 receives the services provided by the VMs operating in the business servers 300, 300a, 300b, . . . . In other words, the client device 500 receives the services that are provided through cloud computing.

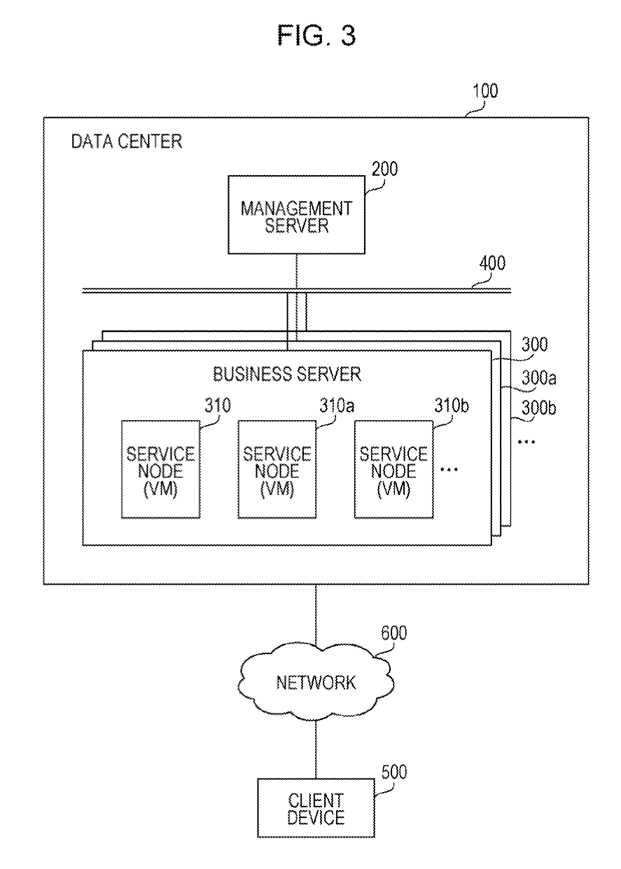

FIG. 3 illustrates an example of a virtual machine operating in the virtual machine extension system of the second embodiment. In the virtual machine extension system, the VMs operate in the business servers 300, 300a, 300b, . . . . Referring to FIG. 3, the VMs operating in the business server 300 are described.

The business server 300 operates service nodes 310, 310a, 310b, . . . as VMs therewithin. The service nodes 310, 310a, 310b, . . . operate when a hypervisor in the business server 300 allocates the resources of the business server 300 to the service nodes 310, 310a, 310b, . . . . The service nodes 310, 310a, 310b, . . . provide services to the client device 500. For example, the service nodes 310, 310a, 310b, . . . provide a voice service or a mail service to the client device 500.

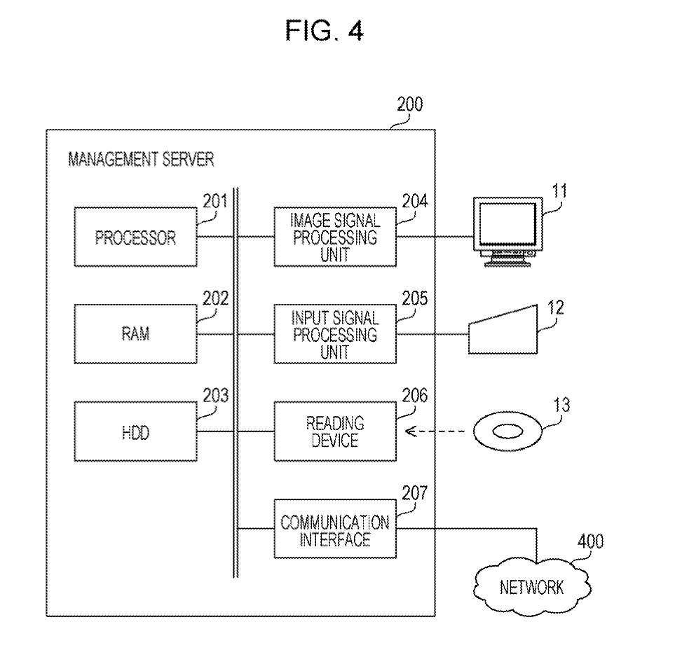

FIG. 4 illustrates a hardware configuration of the management server 200. The management server 200 includes a processor 201, a random-access memory (RAM) 202, a hard disk drive (HDD) 203, an image signal processing unit 204, an input signal processing unit 205, a reading device 206, and a communication interface 207. These units are coupled to a bus of the management server 200.

The processor 201 controls the entire management server 200. The processor 201 may be a multi-processor including multiple processing elements. For example, the processor 201 may be a central processing unit (CPU), a digital signal processor (DSP), an application specific integrated circuit (ASIC), or a field programmable gate array (FPGA). The processor 201 may be a combination of at least two of the CPU, the DSP, the ASIC, and the FPGA.

The RAM 202 is a main memory device of the management server 200. The RAM 202 stores at least temporarily an operating system (OS) and at least part of an application program to be executed by the processor 201. The RAM 202 also stores a variety of data used by the processor 201.

The HDD 203 is an auxiliary storage device of the management server 200. The HDD 203 magnetically writes data to or reads data from a magnetic disk built therein. The HDD 203 stores the OS, the application programs, and a variety of data. The management server 200 may have another type of auxiliary storage device, such as a flash memory or a solid state drive (SSD), or may include multiple storage devices.

In response to a command from the processor 201, the image signal processing unit 204 outputs an image to a display 11 coupled to the management server 200. The display 11 may be one of a variety of displays, including a cathode ray tube (CRT) display, a liquid-crystal display (LCD), and an organic electro-luminescent display (EL).

The input signal processing unit 205 receives an input signal from an input device 12 coupled to the management server 200, and outputs the input signal to the processor 201. The input device 12 may be one of various input devices, including a mouse, a touchpanel, a pointing device, and a keyboard. Multiple input devices may be coupled to the management server 200.

The reading device 206 reads programs or data recorded on a recording medium 13. The recording medium 13 may be a magnetic disc, such as a flexible disk (FD) or HDD, an optical disc, such as a compact disc (CD) or a digital versatile disc (DVD), or a magneto-optical (MO) disc. The recording medium 13 may also be a non-volatile semiconductor memory, such as a flash memory. In response to a command from the processor 201, the reading device 206 stores the program or data read from the recording medium 13 onto the RAM 202 or the HDD 203.

The communication interface 207 communicates with the business servers 300, 300a, 300b, . . . via the network 400.

Each of the business servers 300, 300a, 300b, . . . may be implemented using a hardware configuration similar to that of the management server 200.

With the hardware configuration described above, the VM is used to provide a variety of service to users who use the client devices 500. When a VM providing the service is overloaded, the VM providing the service is scaled out. The state of the service is varying as a scale-out operation is in progress.

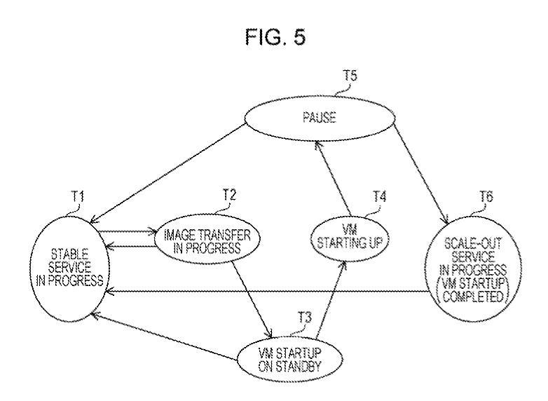

FIG. 5 is a state transition chart of services. FIG. 5 illustrates a transitional process until the VM providing the service is scaled out. The service reaches through states T1 through T6 a state in which the VM is scaled out. When the load value of the VM in the state described below is less than a threshold value, the scale-out operation may be suspended. Each state is described below.

The state T1 indicates a stable service in progress. A threshold value of the traffic amount is set in the service provided by the VM. Unit of the traffic amount is “req/s”. For example, the traffic amount increases as requests from the client device 500 increase in number. With the traffic amount of the service increasing, the load of the VM increases. More specifically, the traffic amount of the service and the load of the VM are correlated with each other. In accordance with the second embodiment, the load of the VM is detected from an increase or decrease in the traffic amount of the service.

When the traffic amount is less than the threshold value, the VM provides a service reliably.

The state T2 indicates that an image for the VM construction is being transferred. When the traffic amount increases and exceeds the threshold value, the VM may be considered to be overloaded. The scale-out operation thus starts to distribute the load. The state T2 indicates the transferring of an image file to a business server that constructs a VM to be added. When the traffic amount is predicted to become less than the threshold value in the state T2, the service transitions back from the state T2 to the state T1.

The state T3 indicates that the VM startup is on standby. In the state T3, the transfer of the image file is complete. When the traffic amount is predicted to become less than the threshold value in the state T3, the service transitions back from the state T3 to the state T1.

The state T4 indicates that the VM is starting up. In the state T4, the startup operation of the scaled-out VM is in progress.

The state T5 indicates a pause. In the state T5, a pause function of a hypervisor of the business server having constructed the scaled-out VM causes the scaled-out VM to pause. The pause function of the hypervisor includes a hibernation function of the VM. In the state T5, information including the scaled-out VM read onto a memory is temporarily stored on the HDD of the business server having constructed the VM. The resource (a processor or a memory) allocated to the scaled-out VM is thus released. When the traffic amount is predicted to become less than the threshold value in the state T5, the service transitions back from the state T5 to the state T1.

The state T6 indicates that a scale-out service is in progress. In the state T6, the scaled-out VM has been started up from the pause state, and the scale-out operation with the resource allocated to the VM has been completed. In the discussion that follows, this state may be referred to as a VM startup completion. When the traffic amount decreases with the scaled-out VM removed in the state T6, the service transitions back from the state T6 to the state T1.

Functions of the management server 200 implementing the scale-out are described below.

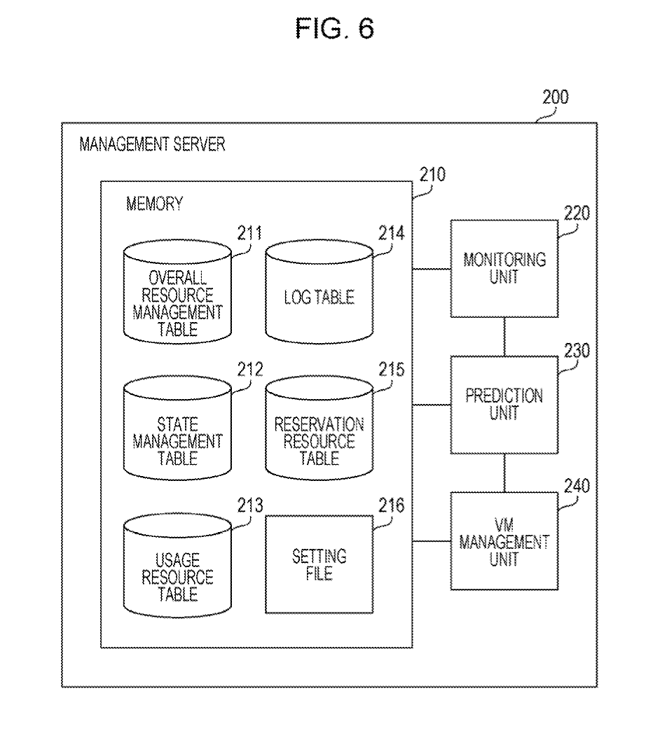

FIG. 6 illustrates a functional example of the management server 200. The management server 200 includes a memory 210, a monitoring unit 220, a prediction unit 230, and a VM management unit 240.

The memory 210 stores information that is used to determine whether the scale-out operation is desired for each service. The memory 210 may be arranged in a memory area reserved on the RAM 202 or the HDD 203. The information stored on the memory 210 includes an overall resource management table 211, a state management table 212, a usage resource table 213, a log table 214, a reservation resource table 215, and a setting file 216.

The overall resource management table 211 registers information indicating an overall sum of amounts of resources of the business servers 300, 300a, 300b, . . . . The state management table 212 registers information indicating the states described with reference to FIG. 5. The usage resource table 213 registers information indicating an amount of resources allocated to the VMs operating in the business servers 300, 300a, 300b, . . . . The log table 214 registers information indicating an amount of traffic provided to a service at a past time point. The reservation resource table 215 registers information indicating an amount of resources to be allocated to a VM that is expected to be newly added in the scale-out operation. The setting file 216 registers the degree of importance of each service.

The monitoring unit 220, the prediction unit 230, and the VM management unit 240 are implemented as a program module that is to be executed by the processor 201.

The monitoring unit 220 acquires at regular intervals an amount of traffic for a service from the VM operating in the business servers 300, 300a, 300b, . . . . The monitoring unit 220 registers the acquired amount of traffic on the log table 214. Based on the acquired amount of traffic, the monitoring unit 220 monitors on a per service basis whether the traffic amount for a service exceeds the threshold value. The monitoring unit 220 determines the VM providing the service whose traffic amount has exceeded the threshold value to be a target for scale-out.

The prediction unit 230 calculates in prediction the traffic amount for the service provided by the VM serving as the scale-out target (predictive traffic amount) at the completion time of the VM startup. The prediction unit 230 calculates a resource amount that is capable of processing the predictive traffic amount (reservation resource amount), and registers the predictive resource amount on the reservation resource table 215.

The VM management unit 240 calculates the priority in view of the degree of importance and urgency of the service. The urgency may be determined in accordance with the predictive traffic amount. For example, the VM management unit 240 determines that as the predictive traffic amount becomes higher, the urgency for making the service as a scale-out target is higher. More in detail, the VM management unit 240 determines the urgency, based on a ratio of an excess amount of the predictive traffic amount above the threshold value to the threshold value (excess traffic ratio). The excess traffic ratio is calculated in accordance with formula (1):

Excess traffic ratio=(Predictive traffic amount−Threshold value)/(Predictive traffic amount)×100 (1)

The VM management unit 240 calculates the priority in accordance with the excess traffic ratio and the degree of importance of the service. The priority is calculated in accordance with formula (2):

Priority=(Excess traffic ratio/100)×Degree of importance (2)

The VM management unit 240 determines a service for which a VM is to be added in accordance with the priority. Upon determining the service for which the VM is added, the VM management unit 240 transmits an image file to a business server which constructs the VM that is newly added through the scale-out operation. The VM management unit 240 instructs the business server to start up the VM.

With this function, the priority of the scale-out operation for the service whose predictive traffic amount has exceeded the threshold value is determined, based on the degree of importance of the service and the excess traffic ratio of the service. The resource is allocated to the VM providing a service having a higher priority, and the scale-out operation is thus performed.

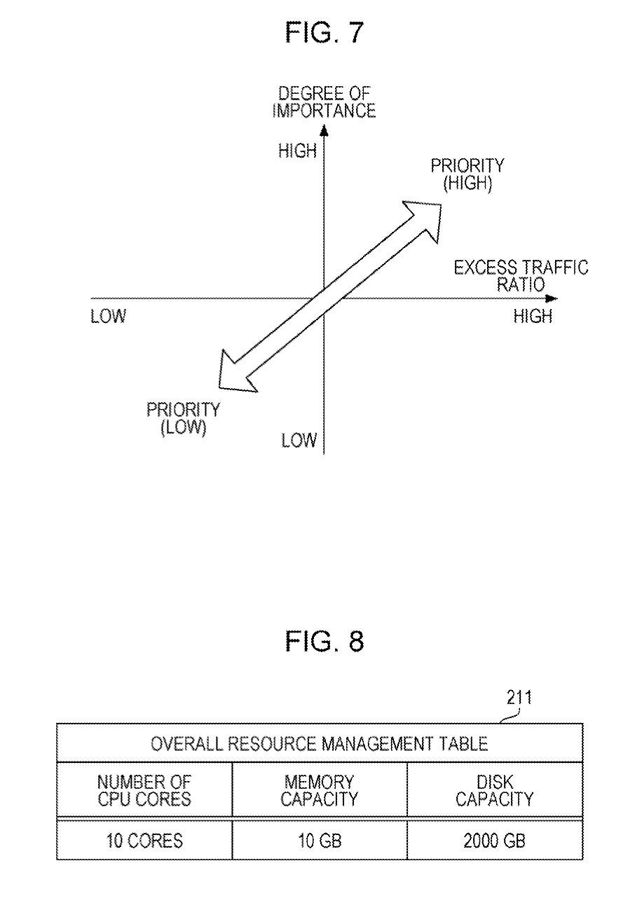

FIG. 7 illustrates a correspondence relationship between the excess traffic ratio and the degree of importance. The ordinate represents the degree of importance of service. A higher position in the upward direction along the ordinate indicates a higher degree of importance while a lower position in the downward direction along the ordinate indicates a lower degree of importance. The abscissa represents the excess traffic ratio. A more rightward position along the abscissa represents a higher excess traffic ratio while a more leftward position along the abscissa represents a lower excess traffic ratio.

The priority is calculated in accordance with formula (2), based on the excess traffic ratio and the degree of importance of the service. For example, FIG. 7 indicates that as the urgency becomes higher with the excess traffic ratio increasing and the degree of importance of the service becomes higher, and the priority becomes higher to add a VM with a higher priority. FIG. 7 also indicates that as the urgency becomes lower with the excess traffic ratio decreasing and the degree of importance of the service becomes lower, and the priority becomes lower because no VM is required to be added.

Information stored on the memory 210 is described in detail.

FIG. 8 illustrates an example of the overall resource management table 211. The overall resource management table 211 is stored on the memory 210. The overall resource management table 211 includes column headings of the number of CPU cores, a memory capacity, and a disk capacity.

The column heading for the number of CPU cores registers a total number of CPU cores of the business servers 300, 300a, 300b, . . . . The column heading for the memory capacity registers a total capacity of the RAMs of the business servers 300, 300a, 300b, . . . . The column heading for the disk capacity registers a total capacity of HDDs of the business servers 300, 300a, 300b, . . . .

For example, the overall resource management table 211 registers “10 cores” as the number of CPU cores, “10 GB” as the memory capacity, and “2000 GB” as the disk capacity.

This indicates that the total number of CPU cores of the business servers 300, 300a, 300b, . . . is “10 cores”, the total capacity of the RAMs thereof is “10 GB”, and the total capacity of the HDDs thereof is “2000 GB”.

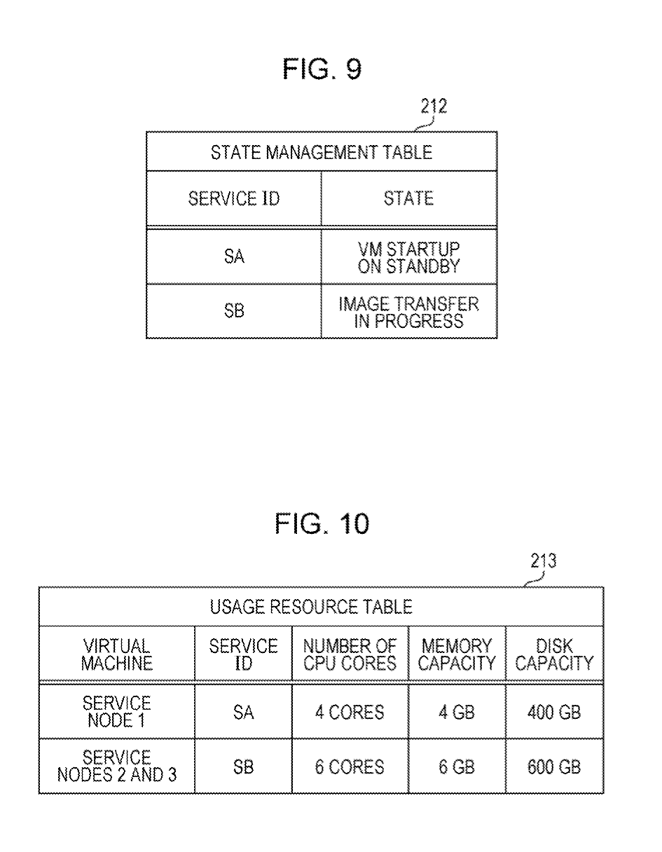

FIG. 9 illustrates an example of the state management table 212. The state management table 212 is stored on the memory 210. The state management table 212 includes column headings for service identifiers (ID), and states.

The column heading for the service ID registers information identifying a service. The column heading for the state registers information indicating the state.

For example, the state management table 212 registers information indicating that the service ID is “SA”, and the state is “VM startup on standby”. This indicates that the scale-out operation of the VM providing the service ID “SA” has started, and that the transfer of the image file to the business server constructing the VM to be added has been completed (“VM startup on standby”).

FIG. 10 illustrates an example of the usage resource table 213. The usage resource table 213 is stored on the memory 210. The usage resource table 213 includes column headings for virtual machines, service IDs, numbers of CPU cores, memory capacities, and disk capacities.

The column heading for the virtual machines registers information indicating each virtual machine. The column heading for the service IDs registers information identifying each service. The column heading for the number of CPU cores registers information indicating the number of CPU cores of each VM currently in operation. The column heading for the memory capacity registers information indicating a memory capacity allocated to the VM currently in operation. The column heading for the disk capacity registers information indicating a disk capacity allocated to the VM currently in operation.

For example, the usage resource table 213 registers a “service node 1” as a virtual machine, “SA” as a service ID, “4 cores” as the number of CPU cores, “4 GB” as a memory capacity, and “400 GB” as a disk capacity.

This indicates that “4 cores” as the number of CPU cores, “4 GB” as a memory capacity, and “400 GB” as a disk capacity are allocated to the virtual machine “service node 1” providing the service ID “SA”.

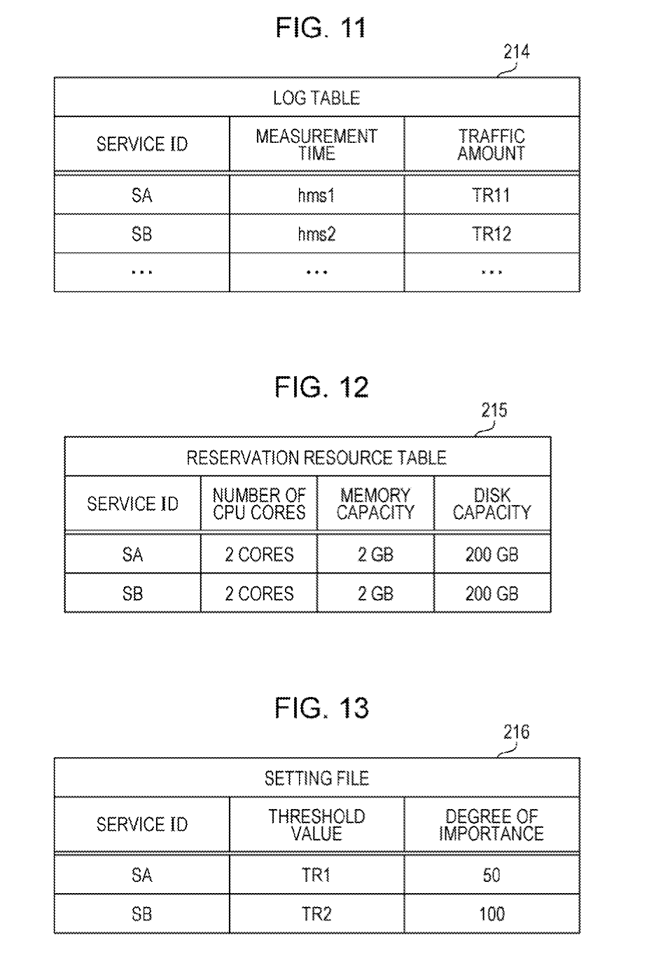

FIG. 11 illustrates an example of the log table 214. The log table 214 is stored on the memory 210. The log table 214 includes column headings for the service IDs, measurement times, and traffic amounts.

The column heading for the service ID registers information identifying the service. The column heading for the measurement time registers information indicating time. The column heading for the traffic amount registers information indicating the traffic amount.

For example, the log table 214 registers “SA” as the service ID, “hms1” as the measurement time, and “TR11” as the traffic amount.

This means that the traffic amount of the service ID “SA” is “TR11” at measurement time “hms1”.

FIG. 12 illustrates an example of the reservation resource table 215. The reservation resource table 215 is stored on the memory 210. The reservation resource table 215 includes column headings for the service IDs, the numbers of CPU cores, the memory capacities, and the disk capacities.

The column heading for the service ID registers information identifying each service. The column heading for the number of CPU cores registers information indicating the number CPU cores allocated to a VM to be added in the scale-out operation. The column heading for memory capacity registers information indicating the memory capacity allocated to the VM to be added in the scale-out operation. The column heading for the disk capacity registers information indicating the disk capacity allocated to the VM to be added in the scale-out operation.

For example, the reservation resource table 215 registers “SA” as a service ID, “2 cores” as the number of CPU cores, “2 GB” as a memory capacity, and “200 GB” for a disk capacity.

This means that “2 cores” as the number of CPU cores, “2 GB” as the memory capacity, and “200 GB” as the disk capacity are reserved as the resources to be allocated to the VM providing the service ID “SA” in the VM scale-out operation.

FIG. 13 illustrates an example of the setting file 216. The setting file 216 is stored on the memory 210. The setting file 216 includes column headings for service IDs, threshold values, and degrees of importance.

The column heading for the service IDs registers information identifying each service. The column heading for the threshold values registers information indicating the threshold value of the traffic amount. The column heading for the degrees of importance registers information indicating the degree of importance of the service.

For example, the setting file 216 registers “SA” as a service ID, “TR1” as a threshold value, and “50” as a degree of importance. This means that the threshold value of the service ID “SA” is “TR1”, and that the degree of importance of the service ID “SA” is “50”.

Using those pieces of information, the priority of the scale-out is appropriately determined on a per service basis. The scale-out operation may be performed on services with a higher priority in the order of higher to lower priority. The service serving as a target of the scale-out operation is started up in a scaled-out state through the state transition of FIG. 5. A determination process as to whether to transition from one state to another as illustrated in FIG. 5 is described in detail.

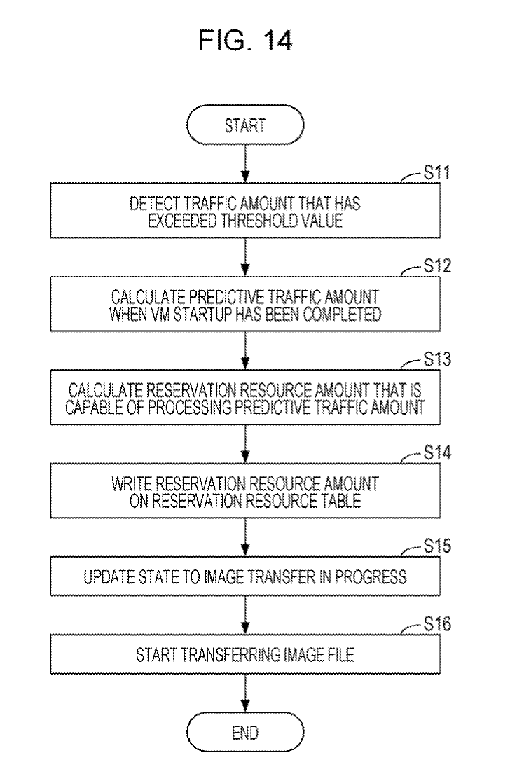

FIG. 14 is a flowchart illustrating a process example 1 of the state transition. Referring to FIG. 14, the service transitions from the state T1 to the state T2. The process of FIG. 14 is described in accordance with step numbers.

S11 The monitoring unit 220 periodically monitors the business servers 300, 300a, 300b, . . . , and detects the traffic amount of a service having exceeded a threshold value. For example, the monitoring unit 220 may detect the traffic amount of the service ID “SA” having exceeded the threshold value. The threshold value is the one listed in the setting file 216.

The monitoring unit 220 determines the VM providing the service whose traffic amount has exceeded the threshold value to be a scale-out target. The process described below is performed on the service whose traffic amount has exceeded the threshold value.

S12 The prediction unit 230 calculates a predicted value (a predictive traffic amount T) of a traffic amount for a service provided by a VM as a scale-out target at the completion time of the VM startup. The predictive traffic amount T is calculated in accordance with formula (3). Let t₀ represent the present time, f₀ represent the traffic amount of the present time, t₁ represent the time when the log of the previous traffic amount is acquired, f₁ represent the traffic amount at the time when the previous log is acquired, and tₐ represent the time period from the present time until the completion of the VM startup. The prediction unit 230 may set the traffic amount detected in step S11 to be the traffic amount f₀. Referring to the log table 214, the prediction unit 230 acquires the time t₁ and the traffic amount f₁. The time period tₐ is determined in accordance with the time period previously measured until the completion of the VM startup.

$$T = \frac{{f}_{0} - {f}_{1}}{{t}_{0} - {t}_{1}} {t}_{a} + {f}_{0} \qquad ( 3 )$$

S13 The prediction unit 230 calculates an amount of reservation resource that is capable of processing the predictive traffic amount for the service. For example, the prediction unit 230 calculates as a reservation resource amount an amount of resource that allows the VM to operate to process a portion of the predictive traffic amount above the threshold value.

The prediction unit 230 determines a business server that constructs a VM that is to be added in the scale-out operation. For example, the prediction unit 230 determines one of the business servers having available resources responsive to the reservation resource amount to be a business server that is to construct the VM.

S14 The prediction unit 230 registers the reservation resource amount on the reservation resource table 215.

S15 The VM management unit 240 updates the state column cell of the state management table 212 from the stable service in progress to the image transfer in progress.

S16 The VM management unit 240 transfers, to the business server configured to construct the VM that is to be newly added in the scale-out operation, an image file for the construction of the VM that provides the service having the traffic amount above the threshold value. The process thus ends.

The calculation of the reservation resource amount is described herein.

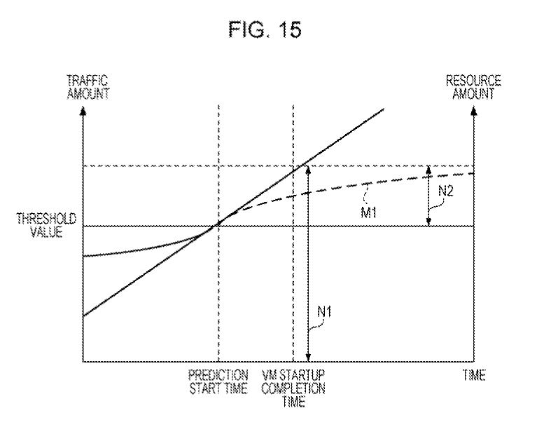

FIG. 15 illustrates the reservation resource amount. In FIG. 15, the left vertical axis represents traffic amount while the right vertical axis represents resource amount. The horizontal axis represents time.

The line M1 predicts that the traffic amount of a certain service exceeds the threshold value and still increases from a prediction start time to the time point of the completion of the VM startup.

A height N1 represents the predictive traffic amount at the completion of the VM startup. A height N2 represents the predictive traffic amount by which the traffic amount increases from the time point where the traffic amount has exceeded the threshold value to the time point of the completion of the VM startup.

As illustrated in FIG. 15, the prediction unit 230 calculates the reservation resource amount such that at least a resource amount capable of processing a traffic amount that increases until the time point of the completion of the VM startup is allocated to the newly added VM as illustrated in FIG. 15.

The case in which the services transitions from the state T2 to the state T3 is described below.

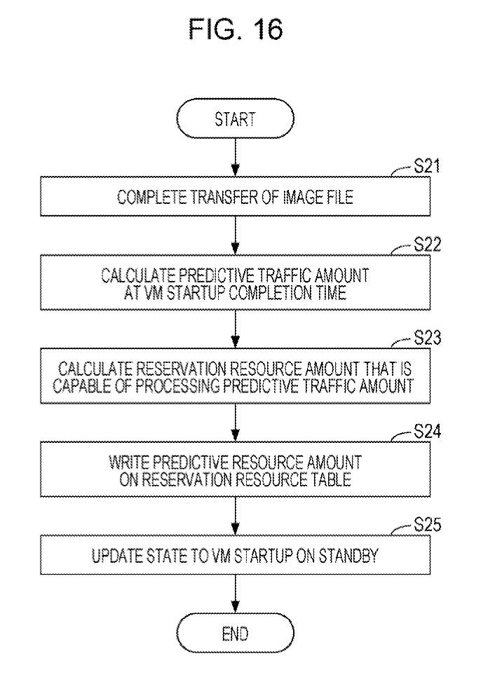

FIG. 16 is a flowchart illustrating a process example 2 of the state transition. Referring to FIG. 16, the service transitions from the state T2 to the state T3, and this process is performed when the image file has been transferred. The process is described in accordance with step numbers of FIG. 16.

S21 The VM management unit 240 has completed the transfer of the image file of the service that is in the state T2.

S22 The prediction unit 230 calculates the predictive traffic amount of the service in the state T2 at the completion of the VM startup. The predictive traffic amount is calculated in accordance with formula (3).

S23 The prediction unit 230 calculates the reservation resource amount that is capable of processing the predictive traffic amount.

S24 The prediction unit 230 registers the reservation resource amount in the reservation resource table 215.

S25 The VM management unit 240 updates the service in the state T2 from the image transfer in progress to the VM startup on standby at the state column cell in the state management table 212. The process ends.

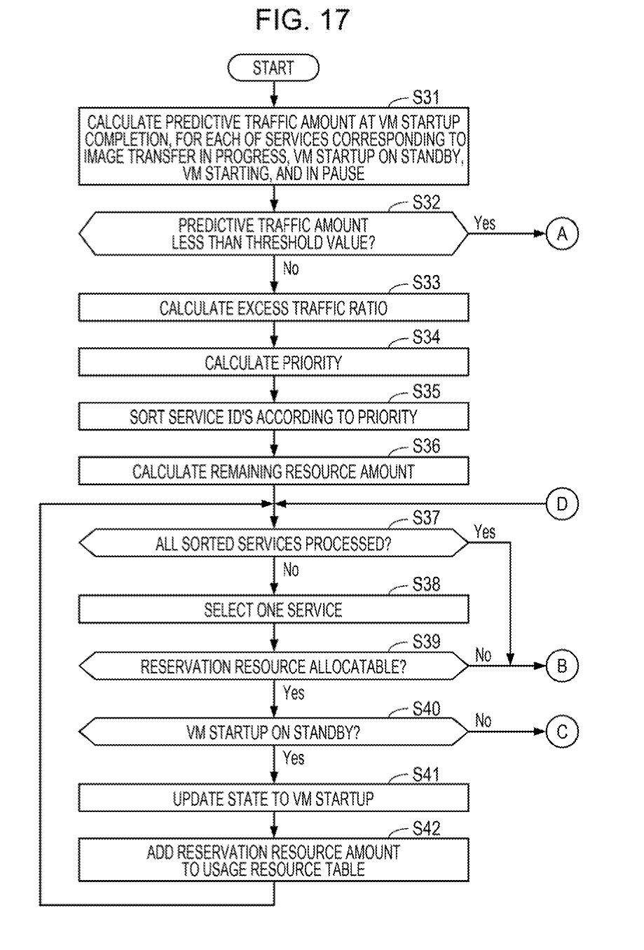

FIG. 17 is a flowchart illustrating a process example 3 of the state transition. The process of FIG. 17 is performed in one of the state T2, the state T3, the state T4, and the state T5. The process of FIG. 17 is periodically performed. The process of FIG. 17 is described in accordance with step numbers.

S31 The prediction unit 230 references the state management table 212, and identifies which of the image transfer in progress, the VM startup on standby, the VM starting, and the pause the service ID at the state column heading corresponds to. The prediction unit 230 calculates the predictive traffic amount at the completion of the VM startup on a per identified service ID basis. The predictive traffic amount is calculated in accordance with formula (3).

S32 The prediction unit 230 references the service ID and the threshold value in the setting file 216 and determines on a per service ID basis whether the predictive traffic amount is less than the threshold value. When the service ID is less than the threshold value, processing proceeds to step S51. When the service ID is equal to or above the threshold value, processing proceeds to step S33.

S33 The VM management unit 240 references the service ID and the threshold value of the setting file 216, and calculates the excess traffic ratio on each of the service IDs that are above the threshold value. The excess traffic ratio is calculated in accordance with formula (1).

S34 The VM management unit 240 references the service ID and the threshold value of the setting file 216, and calculates the priority on each of the service IDs that are above the threshold value. The priority is calculated in accordance with formula (2).

S35 The VM management unit 240 associates the service IDs with the priorities, and sorts the service IDs in the order of from higher to lower priority.

S36 The VM management unit 240 calculates remaining the resource amount. More specifically, the VM management unit 240 subtracts all the resource amount registered in the usage resource table 213 from the resource amount registered in the overall resource management table 211 to calculate the remaining resource amount.

S37 The VM management unit 240 determines whether all the services sorted have been processed. When the services are processed, the process ends. When not all the services are processed, processing proceeds to step S38.

S38 The VM management unit 240 selects one service in the order of sort.

S39 The VM management unit 240 determines whether the reservation resource amount registered in the reservation resource table 215 is allocatable as the remaining resource amount. When the reservation resource amount is allocatable, the VM management unit 240 transmits a VM startup command to a business server that constructs a VM to be newly added in the scale-out operation. Processing proceeds to step S40. When the reservation resource amount is not allocatable, the process ends.

In the second round of this process thereafter, the VM management unit 240 subtracts the reservation resource amount used in the previous determination from the remaining resource amount. Using the remaining resource as a subtraction result, the VM management unit 240 determines whether the reservation resource amount is allocatable.

S40 The VM management unit 240 references the state management table 212 and determines whether the column heading for the service selected in step S38 indicates the VM startup on standby. When the column heading for the service selected in step S38 lists the VM startup on standby, processing proceeds to step S41. When the column heading for the service selected in step S38 does not list the VM startup on standby, processing proceeds to step S61.

S41 The VM management unit 240 updates the status column heading in the state management table 212 from the VM startup on standby to the VM starting.

S42 The VM management unit 240 adds the reservation resource amount to the usage resource table 213. Processing proceeds to step S37.

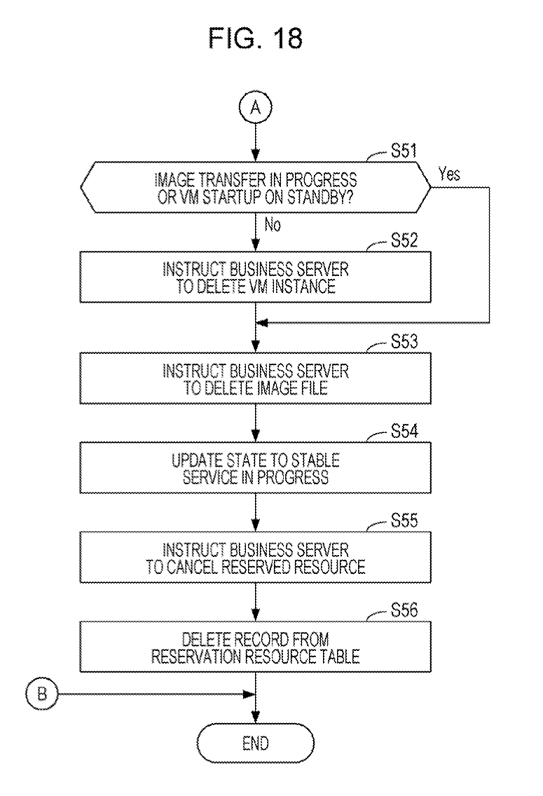

FIG. 18 is a flowchart illustrating a process performed when the predictive traffic amount becomes less than the threshold value. The process of FIG. 18 is described in accordance with step numbers.

S51 The VM management unit 240 determines whether the state column heading in the state management table 212 lists the image transfer in progress or the VM startup on standby. When the state column heading in the state management table 212 lists the image transfer in progress or the VM startup on standby, processing proceeds to step S53. When the state column heading in the state management table 212 lists neither the image transfer in progress nor the VM startup on standby, processing proceeds to step S52.

S52 The VM management unit 240 instructs the business server having received the transferred image file to delete a VM instance.

S53 The VM management unit 240 instructs the business server having received the transferred image file to delete the image file.

S54 The VM management unit 240 updates the state column cell in the state management table 212 to the stable service in progress.

S55 The VM management unit 240 instructs the business server having received the image file to release the reserved resource.

S56 The VM management unit 240 deletes from the reservation resource table 215 the record of the service ID provided by the VM whose scale-out is canceled. The process thus ends.

With the VM starting up in the process of FIG. 18, the VM management unit 240 may wait until a VM that is to be newly added in the scale-out is constructed, then delete the VM instance and the image file, and transition to the stable service in progress. The VM management unit 240 instructs the reserved resource to be canceled, and deletes the record from the reservation resource table 215.

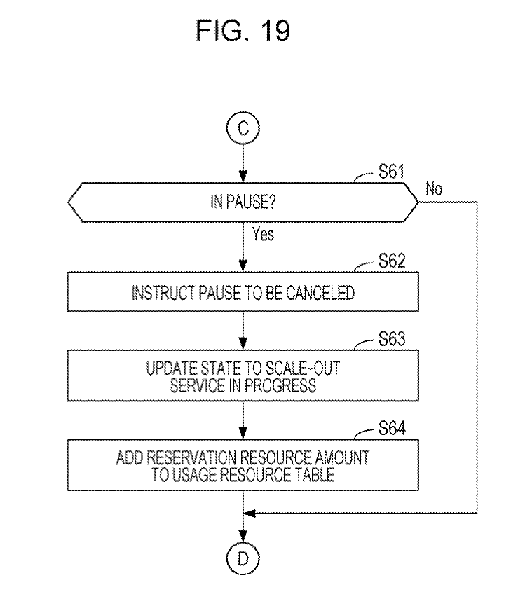

FIG. 19 is a flowchart illustrating a process performed when a reservation resource amount is allocatable with a virtual machine (VM) startup not on standby. The process of FIG. 19 is described below in accordance with step numbers.

S61 The VM management unit 240 references the state management table 212, and determines whether the state column cell corresponding to the service selected in step S38 is in pause. When it is in pause, processing proceeds to step S62. When it is not in pause, processing returns to step S37.

S62 The VM management unit 240 transmits a cancel command to cancel the pause to the business server that has constructed the VM that is to be newly added in the scale-out.

S63 The VM management unit 240 updates the state column cell in the state management table 212 from the pause to the scale-out service in progress.

S64 The VM management unit 240 adds a reservation resource amount to the usage resource table 213. Processing returns to step S37.

The processes of FIG. 17 through FIG. 19 are repeated while the construction operation of the virtual machine is performed. With the calculation of the priority repeated, the service of the virtual machine as an extension target is appropriately determined in accordance with the predictive load value that dynamically changes.

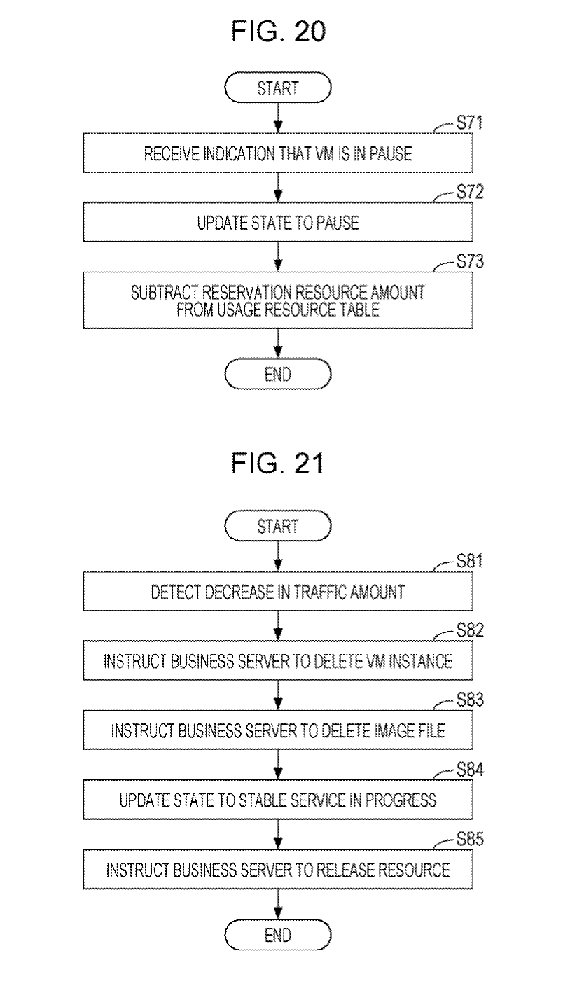

FIG. 20 is a flowchart illustrating a process example 4 of the state transition. Referring to FIG. 20, the service transitions from the state T4 to the state T5. The process of FIG. 20 is described in accordance with step numbers.

S71 The VM management unit 240 receives an indication from a business server that the VM is set to be in pause by the pause function of the hypervisor of the business server that has constructed the VM to be newly added through the scale-out.

S72 The VM management unit 240 updates the state column cell in the state management table 212 from the VM starting to the pause.

S73 The VM management unit 240 subtracts the reservation resource amount registered in the reservation resource table 215 from the usage resource table 213. The process thus ends.

In step S71, the VM management unit 240 has received an indication that the VM is set to be in pause by the pause function of the hypervisor. At the moment of the reception, the pause function of the hypervisor releases the resource allocated to the newly added VM. When the pause function of the hypervisor does not include the hibernation function, the VM management unit 240 may instruct the business server having the hypervisor to release the resource. This releases the resource that has been allocated to the VM having the service with a lower priority, and when the VM having the service with a higher priority is to be scaled out, the resource may be more easily acquired.

FIG. 21 is a flowchart illustrating a process example 5 of the state transition. Referring to FIG. 21, the service transitions from the state T6 to the state T1. The process of FIG. 21 is described in accordance with step numbers.

S81 The monitoring unit 220 periodically monitors the business servers 300, 300a, 300b, . . . , and detects a decrease in the traffic amount of the service provided by the VM that has been scaled out.

S82 The VM management unit 240 instructs the business server having received the image file to delete the VM instance.

S83 The VM management unit 240 instructs the business server having received the image file to delete the image file.

S84 The VM management unit 240 updates the state column cell in the state management table 212 from the scale-out service in progress to the stable service in progress.

S85 The VM management unit 240 instructs the business server having received the image file to release the resource. The process thus ends.

Through the above processes, the priority is calculated in a stepwise fashion until the scale-out, and each time an appropriate priority determination is performed. As a result, as the traffic amount dynamically changes, the urgency of the scale-out changes. In step with a change in the urgency, the scale-out operation may be performed on an appropriate service. In accordance with the second embodiment, the priority is repeatedly calculated. For example, when the predictive traffic amount is less than the threshold value in step S32, processing proceeds to the deletion operation of the VM instance to be scaled out with the priority not calculated. In this way, the addition of a virtual machine that may not be desired is avoided, and a load involved in the calculation operation of the priority is thus reduced.

The scale-out operation is specifically described below.

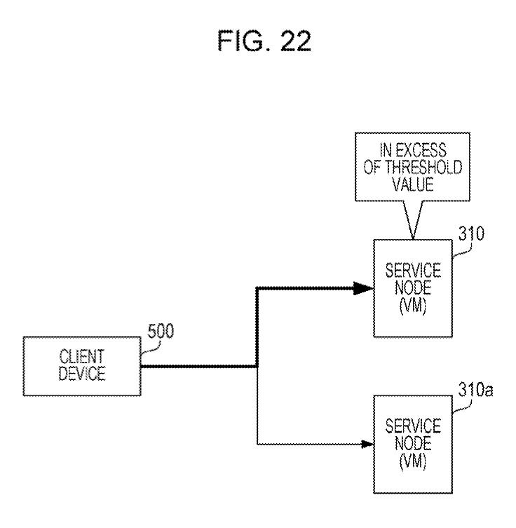

FIG. 22 illustrates a specific example 1 of the scale-out operation. In the specific example, a service node 310 may now provide a service ID “SA”. A service node 310a may provide a service ID “SB”.

Referring to FIG. 22, an increase in the number of accesses from the client device 500 has caused the traffic amount of the service ID “SA” to exceed the threshold value.

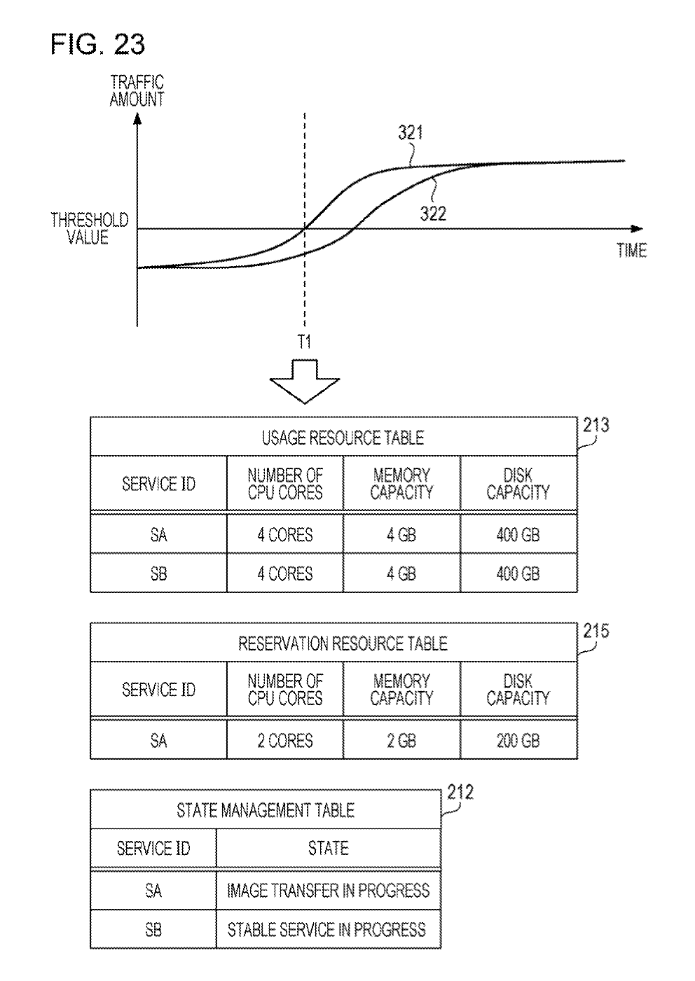

FIG. 23 illustrates a specific example 2 of the scale-out operation. A graph indicating a relationship between traffic amount and time with respect to the service ID “SA” and the service ID “SB” is illustrated at a top portion of FIG. 23. In the graph, the ordinate represents traffic amount, and the abscissa represents time. A curve 321 represents the traffic amount of the service ID “SA”. A curve 322 represents the traffic amount of the service ID “SB”. Referring to FIG. 23, the traffic amounts of the service ID “SA” and the service ID “SB” are indicated at a time point T1. The same threshold value of the traffic amount is applied to the service ID “SA” and the service ID “SB”. At time point T1, the traffic amount for the service ID “SA” reaches the threshold value. This state is represented in FIG. 22. On the other hand, the traffic amount for the service ID “SB” remains unreached to the threshold value at time point T1.

Through periodical monitoring, the monitoring unit 220 detects the traffic amount of the service ID “SA” that has exceeded the threshold value. The prediction unit 230 calculates the predictive traffic amount of the service ID “SA” at the completion of the VM startup, and calculates the reservation resource amount that is capable of processing the predictive traffic amount. The prediction unit 230 registers the reservation resource amount in the reservation resource table 215. The VM management unit 240 updates the state column cell in the state management table 212 for the service ID “SA” from the stable service in progress to the image transfer in progress. The VM management unit 240 transfers the image file to the business server that constructs the VM that is to be newly added in the scale-out.

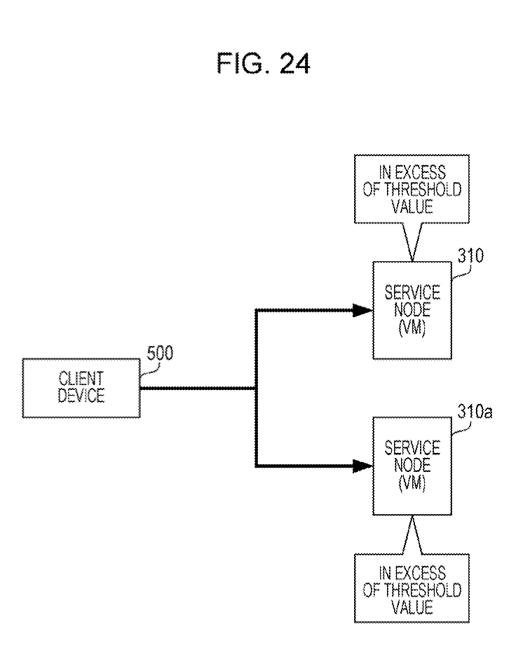

FIG. 24 illustrates a specific example 3 of the scale-out operation. Referring to FIG. 24, an increase in the number of accesses from the client device 500 has caused the traffic amount of the service ID “SB” to exceed the threshold value.

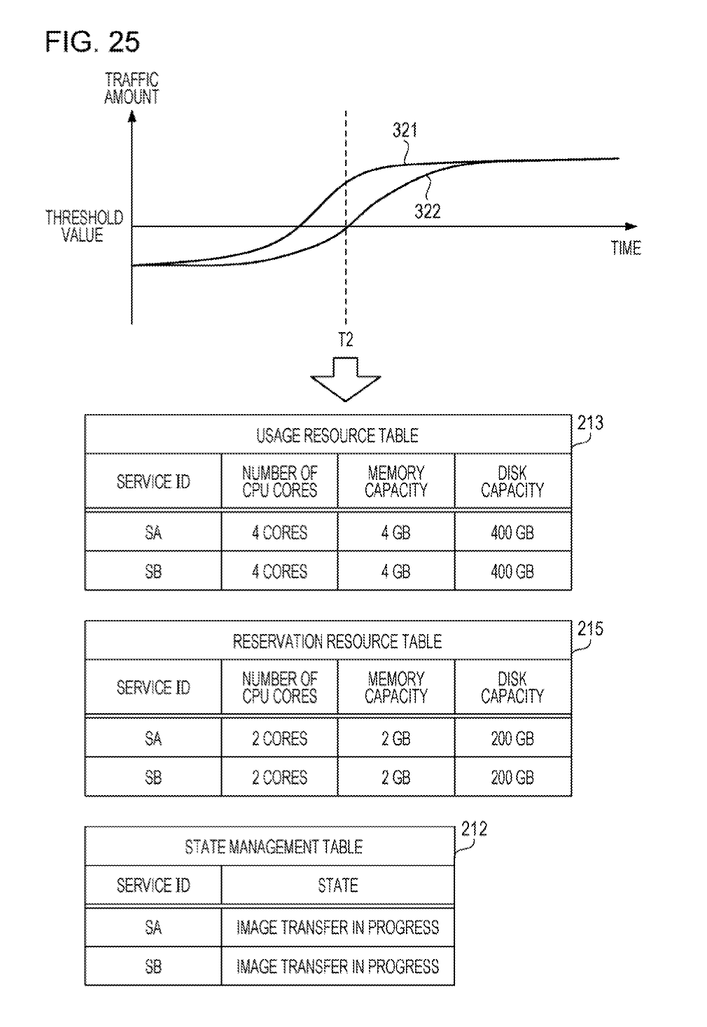

FIG. 25 illustrates a specific example 4 of the scale-out operation. FIG. 25 illustrates the traffic amounts of the service ID “SA” and the service ID “SB” at time point T2. At time point T2, the traffic amount of the service ID “SB” has reached the threshold value. This state is represented by FIG. 24.

Through periodical monitoring, the monitoring unit 220 detects the traffic amount of the service ID “SB” that has exceeded the threshold value. The prediction unit 230 calculates the predictive traffic amount of the service ID “SB” at the completion of the VM startup, and calculates the reservation resource amount that is capable of processing the predictive traffic amount. The prediction unit 230 registers the reservation resource amount in the reservation resource table 215. The VM management unit 240 updates the state column cell in the state management table 212 for the service ID “SB” from the stable service in progress to the image transfer in progress. The VM management unit 240 transfers the image file to the business server that constructs the VM that is to be newly added in the scale-out.

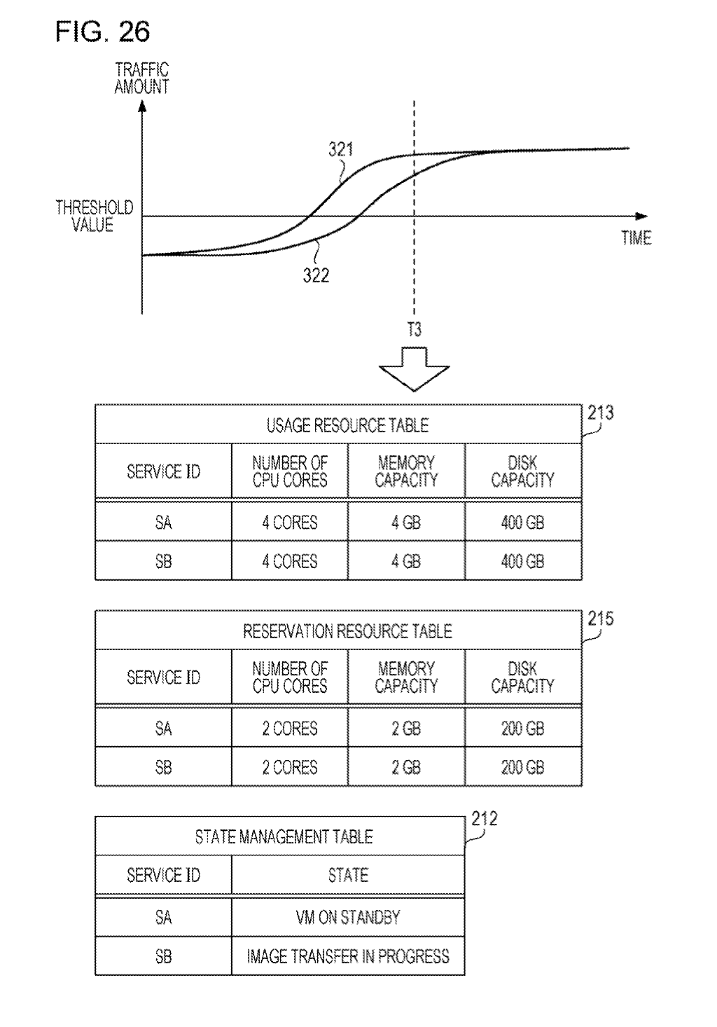

FIG. 26 illustrates a specific example 5 of the scale-out operation. FIG. 26 illustrates the traffic amounts of the service ID “SA” and the service ID “SB” at time point T3.

When the transfer of the image has been completed, the prediction unit 230 again calculates the predictive traffic amount of the service ID “SA” at the completion of the VM startup, and calculates the reservation resource amount that is capable of processing the predictive traffic amount. The prediction unit 230 registers the reservation resource amount in the reservation resource table 215. The VM management unit 240 updates the state column cell in the state management table 212 for the service ID “SA” to the VM startup on standby.

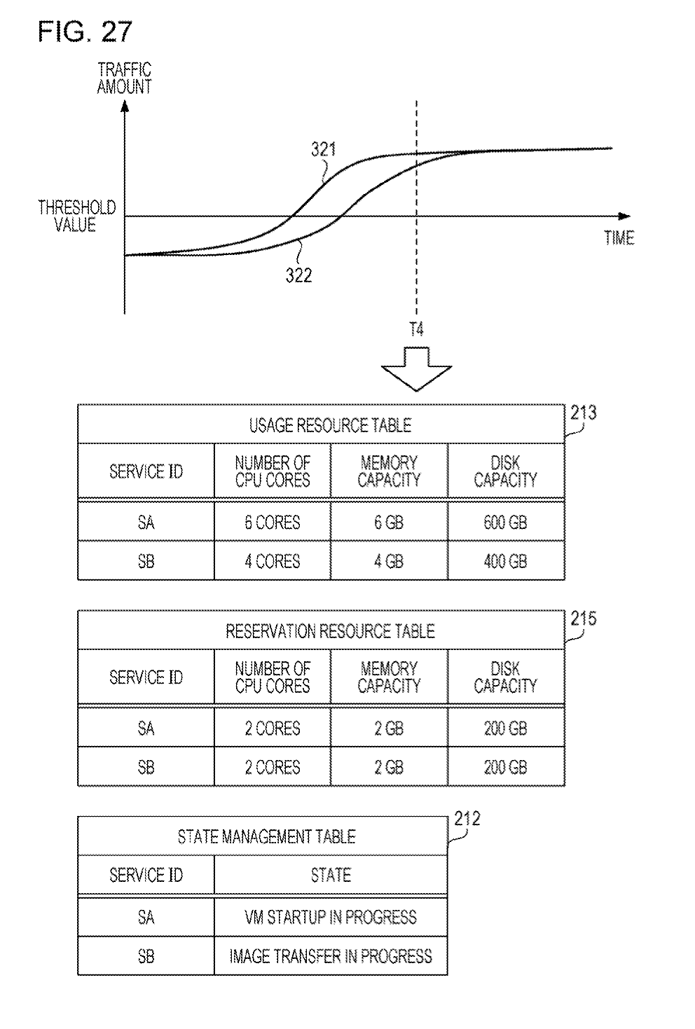

FIG. 27 illustrates a specific example 6 of the scale-out operation. FIG. 27 illustrates the traffic amounts of the service ID “SA” and the service ID “SB” at time point T4.

The prediction unit 230 calculates the predictive traffic amounts of the service ID “SA” and the service ID “SB” at the completion of the VM startup. The VM management unit 240 calculates the priorities of the service ID “SA” and the service ID “SB”, whose predictive traffic amounts are equal to or above the threshold value. The VM management unit 240 determines that there remains a resource that may be allocated to a VM that is to be newly added for the service ID “SA”. The VM management unit 240 transmits a VM startup command to the business server which is going to newly construct a VM. The VM management unit 240 updates the state column cell in the state management table 212 for the service ID “SA” to the VM startup in progress. The VM management unit 240 adds the reservation resource amount of the service ID “SA” to the usage resource table 213.

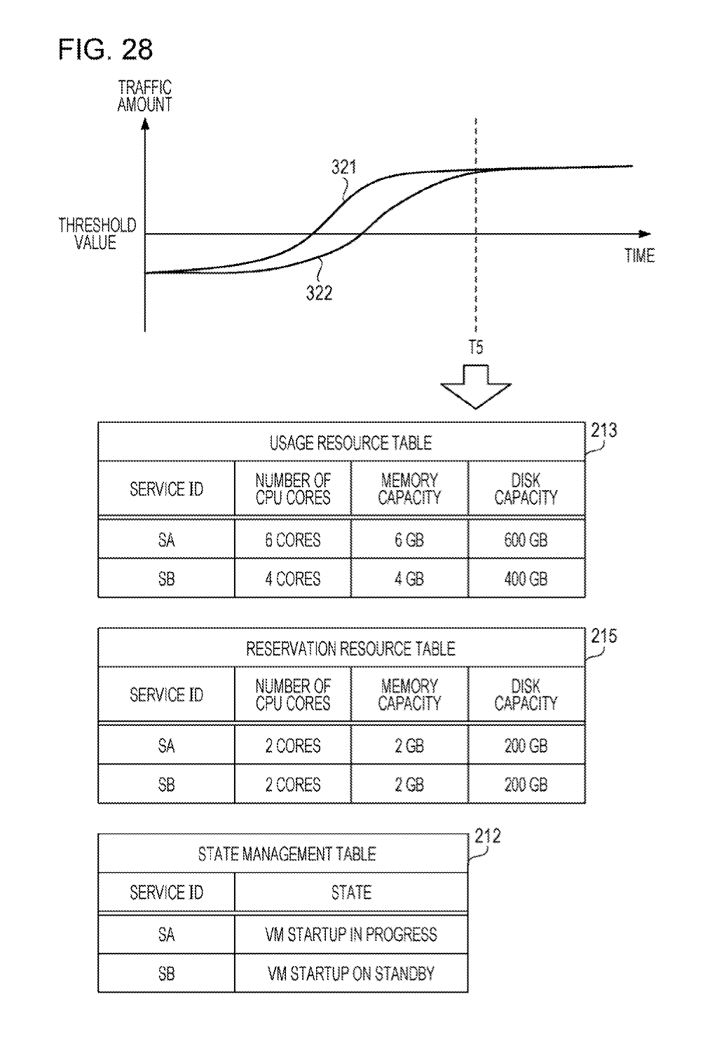

FIG. 28 illustrates a specific example 7 of the scale-out operation. FIG. 28 illustrates the traffic amounts of the service ID “SA” and the service ID “SB” at time point T5.

When the transfer of the image has been completed, the prediction unit 230 again calculates the predictive traffic amount of the service ID “SB” at the completion of the VM startup, and calculates the reservation resource amount that is capable of processing the predictive traffic amount. The prediction unit 230 registers the reservation resource amount in the reservation resource table 215. The VM management unit 240 updates the state column cell in the state management table 212 for the service ID “SB” to the VM startup on standby.

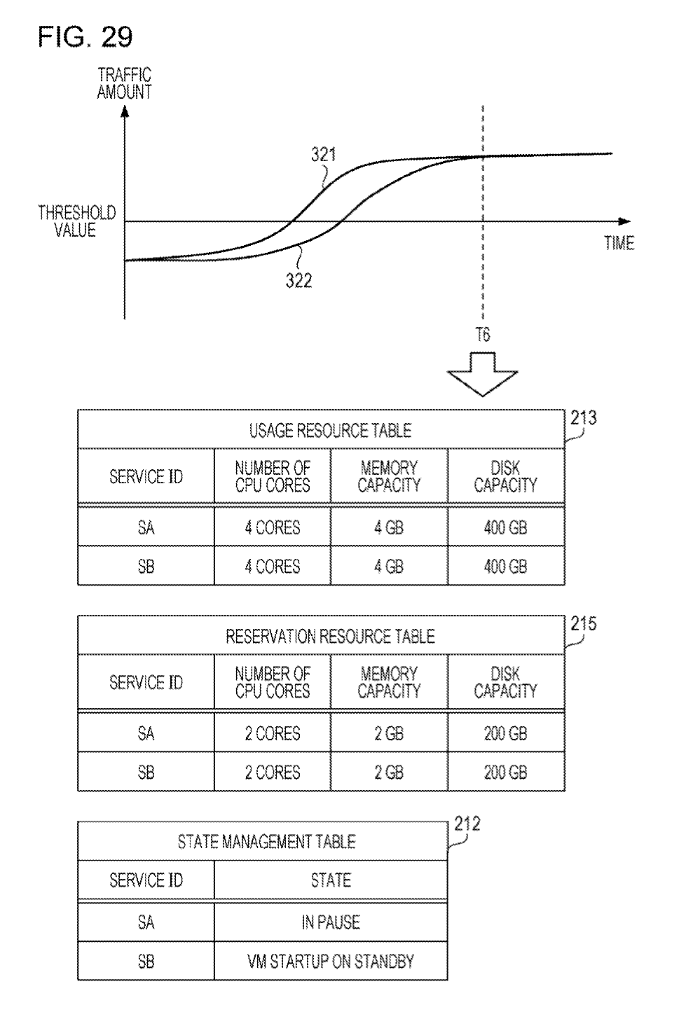

FIG. 29 illustrates a specific example 8 of the scale-out operation. FIG. 29 illustrates the traffic amounts of the service ID “SA” and the service ID “SB” at time point T6.

The VM management unit 240 receives, from the business server that constructs a VM to be newly added for the service ID “SA”, an indication that the VM is set to be in pause. The VM management unit 240 updates the state column cell in the state management table 212 for the service ID “SA” to the pause. The VM management unit 240 subtracts the reservation resource amount from the usage resource table 213 for the service ID “SA”.

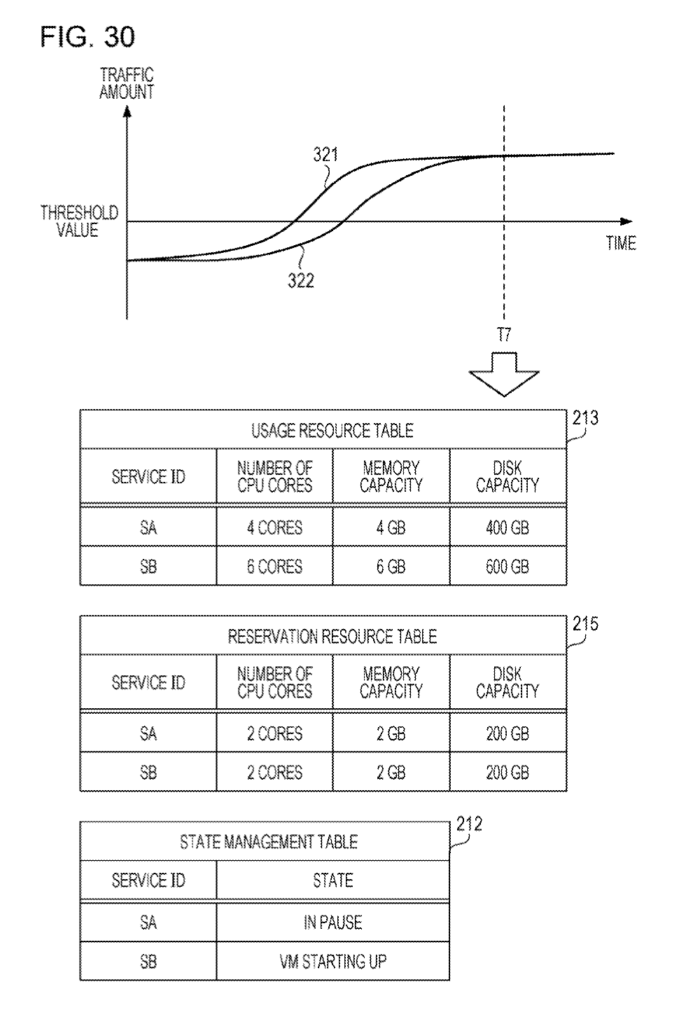

FIG. 30 illustrates a specific example 9 of the scale-out operation. FIG. 30 illustrates the traffic amounts of the service ID “SA” and the service ID “SB” at time point T7.

The prediction unit 230 calculates the predictive traffic amount of the service ID “SA” and the service ID “SB” at the completion of the VM startup. The VM management unit 240 also calculates the priorities of the service ID “SA” and the service ID “SB” whose predictive traffic amount is equal to or above the threshold value. It is assumed herein that the service ID “SB” is higher in priority than the service ID “SA”. The VM management unit 240 determines that there remains a resource to be allocated to a VM that is to be newly added for the service ID “SB”. The VM management unit 240 determines that there remains no resource to be allocated to a VM that is to be newly added for the service ID “SA”. The VM management unit 240 transmits a VM startup command to the business server that constructs the VM that is to be newly added for the service ID “SB”. The VM management unit 240 updates the state column cell in the state management table 212 for the service ID “SB” to the VM starting. The VM management unit 240 adds the reservation resource amount to the usage resource table 213 for the service ID “SB”.

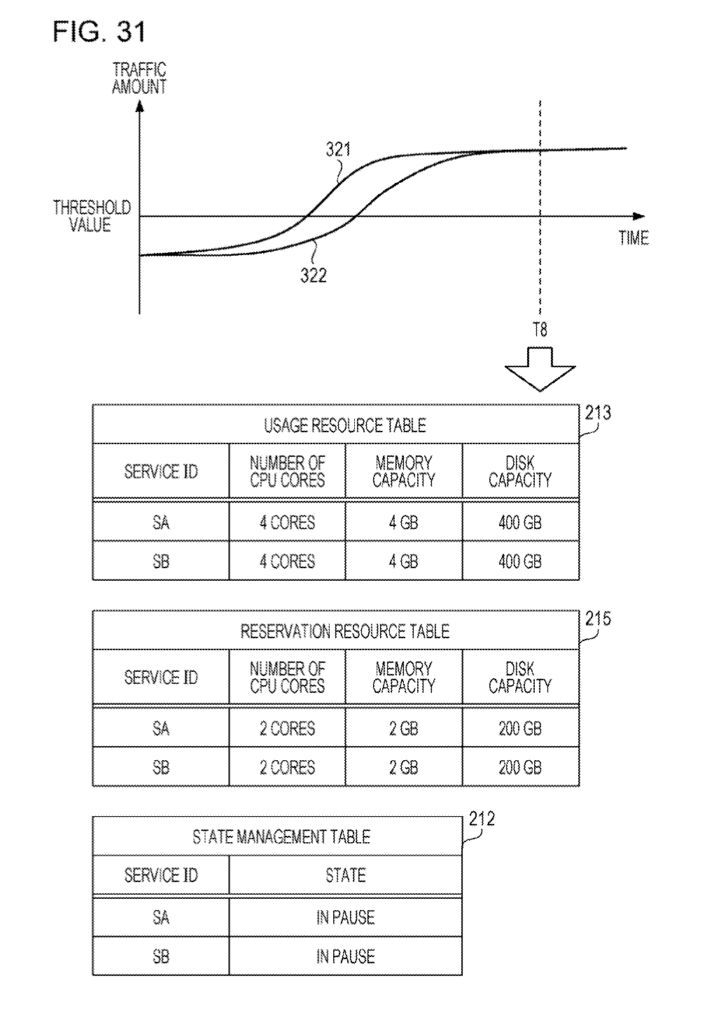

FIG. 31 illustrates a specific example 10 of the scale-out operation. FIG. 31 illustrates the traffic amounts of the service ID “SA” and the service ID “SB” at time point T8.

The VM management unit 240 receives, from the business server that constructs a VM to be newly added for the service ID “SB”, an indication that the VM is set to be in pause. The VM management unit 240 updates the state column cell in the state management table 212 for the service ID “SB” to the pause. The VM management unit 240 subtracts the reservation resource amount from the usage resource table 213 for the service ID “SB”.

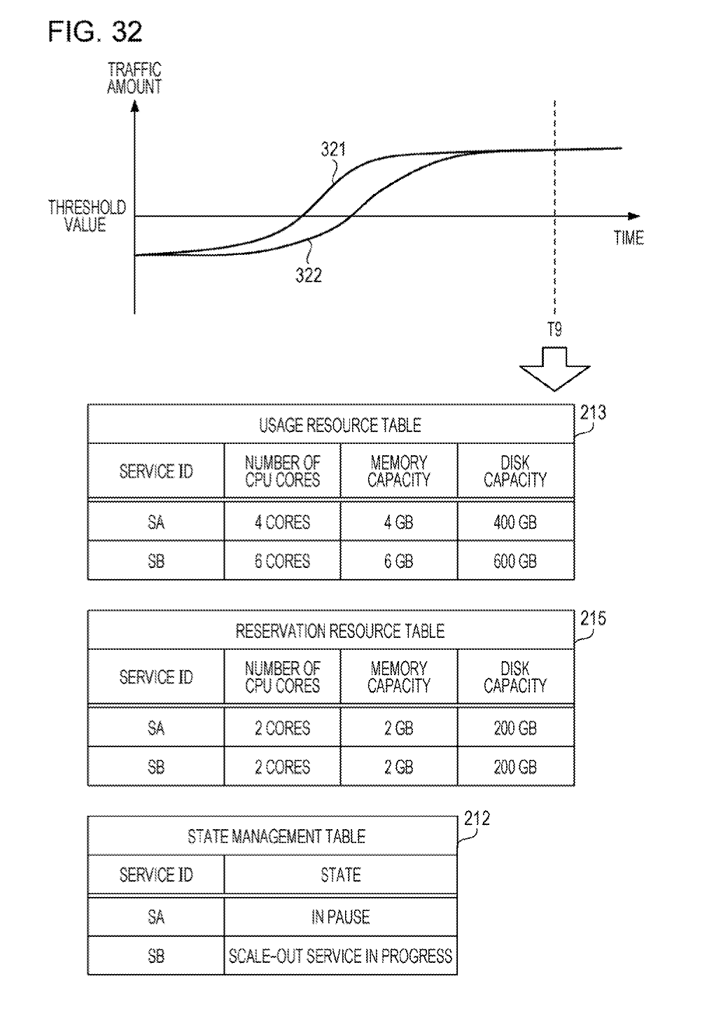

FIG. 32 illustrates a specific example 11 of the scale-out operation. FIG. 32 illustrates the traffic amounts of the service ID “SA” and the service ID “SB” at time point T9.

The prediction unit 230 calculates the predictive traffic amounts of the service ID “SA” and the service ID “SB” at the completion of the VM startup. The VM management unit 240 calculates the priorities of the service ID “SA” and the service ID “SB” whose predictive traffic amounts are equal to or above the threshold value. It is assumed herein that the service ID “SB” is higher in priority than the service ID “SA”. The VM management unit 240 determines that there remains a resource to be allocated to a VM that is to be newly added for the service ID “SB”. The VM management unit 240 determines that there remains no resource to be allocated to a VM that is to be newly added for the service ID “SA”.

The VM management unit 240 instructs the business server that constructs a VM that is to be newly added for the service ID “SB” to cancel the pause. The VM management unit 240 updates the state column cell in the state management table 212 for the service ID “SB” to the scale-out service in progress. The VM management unit 240 adds the reservation resource amount to the service ID “SB” cell in the usage resource table 213.

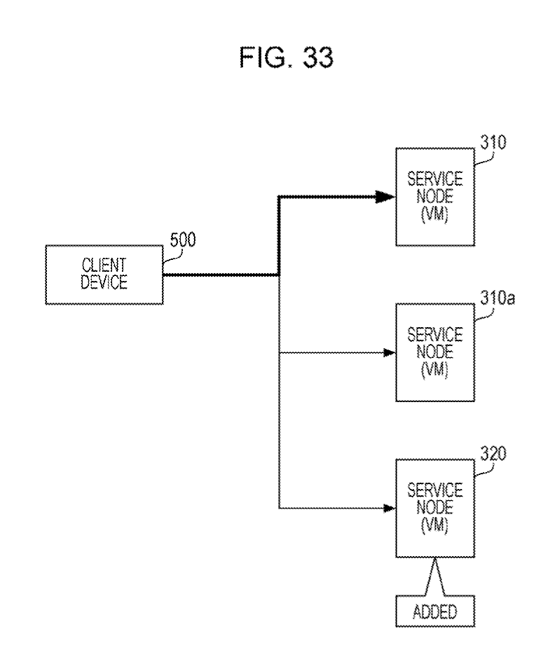

In this way, the VM providing the service ID “SB” is scaled out. FIG. 33 illustrates a specific example 12 of the scale-out operation. FIG. 33 indicates that a service node 320 providing the service ID “SB” has been newly added.

In accordance with the second embodiment, the priority is calculated in view of the degree of importance and urgency of each service. When the service ID “SA” and the service ID “SB” are present for the VM that is to be added, the service ID “SB” for which the VM is added is adequately determined in accordance with the priority. More specifically, the service for which the VM is added is appropriately determined, considering the degree of importance and urgency of the service.

The information processing of the first embodiment may be performed by causing a processor used for the arithmetic unit 1b to execute a program. The information processing of the second embodiment may be performed by causing the processor 201 to execute the program. The program may be recorded on a computer-readable recording medium.

By distributing recording media having recorded the program, the program may be commercially available. Programs implementing the functions of the monitoring unit 220, the prediction unit 230, and the VM management unit 240 may be separate programs, and these programs may be individually distributed. The functions of the monitoring unit 220, the prediction unit 230, and the VM management unit 240 may be implemented by separate computers. A computer may store (install) the program from the recording medium onto the RAM 202 or the HDD 203, and read the program from the memory and execute the program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A virtual machine extension method comprising:
detecting a first virtual machine that provides a first service and a second virtual machine that provides a second service, each having a load that has exceeded a threshold value, from a plurality of virtual machines that provide services;
determining a first priority with which a first extension virtual machine is to be added for the first service, in accordance with a first predictive load value that is a predicted value of a first load of the first virtual machine after a lapse of a specific period of time, and a degree of importance of the first service;
determining a second priority with which a second extension virtual machine is to be added for the second service, in accordance with a second predictive load value that is a predicted value of a second load of the second virtual machine after a lapse of a specific period of time, and a degree of importance of the second service; and
determining, as a preferential extension virtual machine that is to be added with a higher priority, a virtual machine that provides a service having higher one of the first and second priorities.

2. The virtual machine extension method of claim 1, wherein
the first predictive load value is a predicted value of the first load of the first virtual machine after a lapse of a period of time taken from a current point of time to a startup of the first extension virtual machine that is to be added to provide the first service; and
the second predictive load value is a predicted value of the second load of the second virtual machine after a lapse of a period of time taken from the current point of time to a startup of the second extension virtual machine that is to be added to provide the second service.

3. The virtual machine extension method of claim 2, further comprising:
upon detecting that the first load of the first virtual machine has exceeded the threshold value, starting an extension operation for the first extension virtual machine configured to provide the first service;
upon detecting that the second load of the second virtual machine has exceeded the threshold value, starting an extension operation for the second extension virtual machine configured to provide the second service;
in course of the extension operation for the first extension virtual machine, repeating a process to determine the first priority, based on a remaining time period until the startup of the first extension virtual machine;
in course of the extension operation for the second extension virtual machine, repeating a process to determine the second priority, based on a remaining time period until the startup of the second extension virtual machine configured to provide the second service; and
updating a result of determining the preferential extension virtual machine by performing a determination of the preferential extension virtual machine each time the first priority and the second priority are calculated.

4. The virtual machine extension method of claim 3, further comprising:
when a startup of a third extension virtual machine configured to provide a service having a lower priority is completed before a startup of a fourth extension virtual machine configured to provide a service having a higher priority, releasing a resource by saving a state of the third extension virtual machine in a memory; and
allocating the resource to the fourth virtual machine, and starting up the fourth virtual machine.

5. The virtual machine extension method of claim 3, further comprising:
suspending the extension operation for the first extension virtual machine when the first predictive load value becomes less than the threshold value; and
suspending the extension operation of the second extension virtual machine when the second predictive load value becomes less than the threshold value.

6. An information processing apparatus comprising:
a memory configured to store setting information indicating a correspondence relationship between services provided by virtual machines and degrees of importance of the services; and
a processor coupled to the memory and configured to:
detect a first virtual machine that provides a first service and a second virtual machine that provides a second service, each having a load that has exceeded a threshold value, from a plurality of virtual machines that provide services,
determine a first priority with which a first extension virtual machine is to be added for the first service, in accordance with a first predictive load value that is a predicted value of a first load of the first virtual machine after a lapse of a specific period of time, and a degree of importance of the first service,
determine a second priority with which a second extension virtual machine is to be added for the second service, in accordance with a second predictive load value that is a predicted value of a second load of the second virtual machine after a lapse of a specific period of time, and a degree of importance of the second service, and
determine, as a preferential extension virtual machine that is to be added with a higher priority, a virtual machine that provides a service having higher one of the first and second priorities.

7. A virtual machine extension system comprising:
a plurality of information processing apparatuses each including a first processor configured to cause a plurality of virtual machines that provide services, to operate; and
a management apparatus including a second processor configured to:
detect a first virtual machine that provides a first service and a second virtual machine that provides a second service, each having a load that has exceeded a threshold value, from a plurality of virtual machines that provide services,
determine a first priority with which a first extension virtual machine is to be added for the first service, in accordance with a first predictive load value that is a predicted value of a first load of the first virtual machine after a lapse of a specific period of time, and a degree of importance of the first service,
determine a second priority with which a second extension virtual machine is to be added for the second service, in accordance with a second predictive load value that is a predicted value of a second load of the second virtual machine after a lapse of a specific period of time, and a degree of importance of the second service, and
determine, as a preferential extension virtual machine that is to be added with a higher priority, a virtual machine that provides a service having higher one of the first and second priorities.
